(19) United States
(12) Patent Application Publication
(10) Pub. No.: US 2013/0254223 A1
(43) Pub. Date: Sep. 26, 2013

(54) SEARCH FOR RELATED ITEMS USING DATA CHANNELS

(71) Applicant: Raymond Lau, Charlestown, MA (US)

(72) Inventor: Raymond Lau, Charlestown, MA (US)

(73) Assignee: RAMP HOLDINGS, INC., Woburn, MA (US)

(21) Appl. No.: 13/427,809

(22) Filed: Mar. 22, 2012

(51) Int. Cl. G06F 17/30

(52) U.S. Cl. 707/769; 707/E17.014

(57) ABSTRACT

Methods and apparatus, including computer program products, for a search for related items using data channels. A method includes, in a computing system having a processor and memory, processing data channels, each data channel defining a set of criteria against which to match items, receiving an input item, and applying the data channels to identify one or more additional items related to the input item.

### BACKGROUND OF THE INVENTION

The present invention generally relates to search techniques, and more particularly to a search for related items using data channels.

Given one item, such as a text document, prior techniques have attempted to find other items that may be related to the one item, such as on similar topic, or of interest to similar persons. Many of these prior techniques are based on analyzing the words associated with items and determining similarities statistically, e.g. counting overlap in number of words, weighing the overlap by a metric such as frequency—inverse document frequency, weighing titles separately from words in the body. Sometimes a first pass consisting of finding the most relevant words is performed to permit faster calculation of the statistics.

Other techniques are based on consumption patterns. For example, if a number of people who read a first item go on to read a second item, there is likely a good relationship between the two items.

Trainable classification systems may use machine learning techniques to learn patterns based on editorially designated training sets of related items in order to identify further related items.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for a search for related items using data channels.

In general, in one aspect, the invention features a method including processing data channels, each data channel defining a set of criteria against which to match items, receiving an input item, and applying the data channels to identify one or more additional items related to the input item.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The invention will be more fully understood by reference to the detailed description, in conjunction with the following figures, wherein:

FIG. 1 is a block diagram.

FIG. 2 is a flow diagram.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

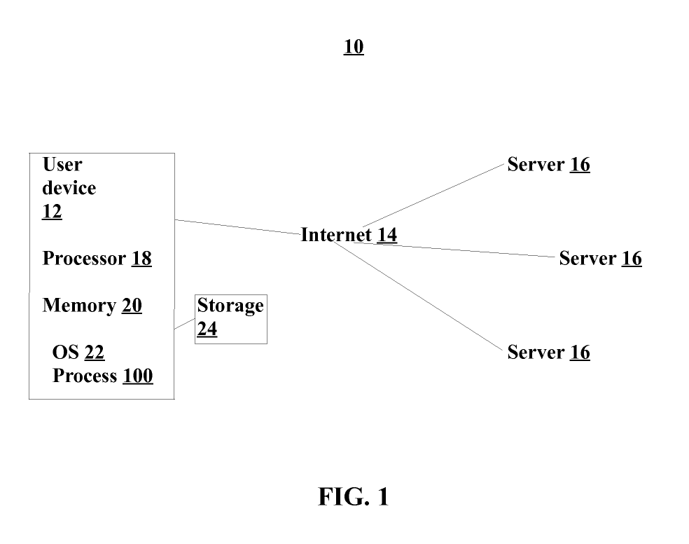

As shown in FIG. 1, an exemplary network 10 includes a user device 12 linked to group of interconnect computers (e.g., Internet) 14. The network 10 includes one or more servers 16 linked to the Internet 14.

The user device 12 includes a processor 18 and a memory 20. The memory 20 includes an operating system (OS) 22, such as Windows®, Linux® or Android®, and a search process 100. Example user devices include laptop computers, netbook computers, tablet computers, smartphones and so forth. The user device 12 may also include a storage device 24. Items may be stored in the memory 20 or in the storage device 24, or both. Process 100 works with items. An item can contain one or more items. Each item can include a text document, an audio clip, a video clip, an image, and so forth. Each item may include a grouping of items, such as, for example, a set of video clips making up the scenes of a movie. Process 100 finds items that may be related and are relevant to a particular user's requirements or to a specific item in a collection of items.

Process 100 performs in conjunction with data channels. As used herein, “data channels” refer to a definition of a set of criteria against which to match items. Data channel definitions may include search words. Data channel definitions may include metadata criteria. For example, metadata criteria may refer to an item published between Jan. 1, 2012, and Jan. 31, 2012, by a particular author or authors, and so forth.

Data channel definitions may include generated metadata criteria. For example, generated metadata criteria may include categories determined by a natural language processor.

A data channel may be expressed as a Boolean tree of criteria, for example, ((Tom or Thomas) and Brady) and Classification=Football.

Using data channels to find related items have the benefit of being editorially defined, though not always. Data channels can also be automatically generated based on analyzing trending topics on the web (or elsewhere), analyzing content relevant to a proposed data channel, and so forth. Even in the automated case, editorial review is possible to better improve the precision of the data channels.

Data channels tend to be higher quality than purely statistical approaches and more scalable than purely manual editorial approaches.

In general, all of the items matching a particular data channel are related. In some cases, many items match multiple data channels. Process 100 uses the number of data channel matches as an indication of the degree of relatedness of items.

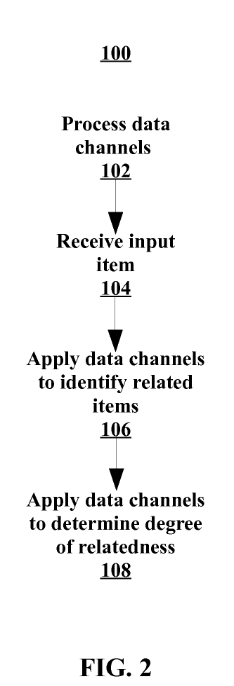

As shown in FIG. 2, process 100 includes processing (102) data channels. Each data channel defines a set of criteria against which to match items. The set of criteria can include, for example, search words, metadata criteria, generated metadata criteria, and so forth. The data channels may include Boolean trees of criteria.

Processing (102) data channels can include analyzing trending topics on the world wide web (WWW).

Process 100 receives (104) an input item. Process 100 applies (106) the data channels to identify one or more additional items related to the input item.

For example, for a given item (“I”—for which we want to identify related items), identify the set of data channels (“D”) that would include that item. Consider the set of all other items (“O”) which would be included by “D.” “O” is the candidate set of related items. “O” may be filtered by additional constraints. For a given target item (“T”) in “O,” the degree of relatedness between “T” and “I” can be calculated by:

The size of the subset of “D” which include both “T” and “I” is one indicator of relatedness.

Process 100 can apply (108) the data channels to identify a degree of relatedness between the first item and the one or more additional items. Applying (108) the data channels to identify a degree of relatedness can include determining a number of data channels in common to which two given items belong. The degree of relatedness can be refined by a relevance score for an item to a given data channel.

The relevance score can be derived from a number of nodes matched in a Boolean tree representation of the data channel set of criteria. The relevance score can be derived from a number of matches in the first item for a match criterion.

Continuing with the example described above, for a given data channel that includes both “T” and “I,” a score can be attached. The score can be the degree of match between that data channel and “T,” and also between that data channel and “I.” The score can be the number of nodes matched in the Boolean tree for the data channel (although data channels do not always have to be Boolean trees). For example, a data channel with ((“Thomas” or “Tom”) and “Jefferson”) will have a score of 2 for a document mentioning “Thomas Jefferson” once, but not “Tom Jefferson,” but a score of 4 for a document mentioning both “Thomas Jefferson” once and “Tom Jefferson” once.

This score can also be further influenced using statistical measures like frequency—inverse document frequency (TF-IDF) weighing, so that a match for “Jefferson” counts more than a match for “Thomas” as “Jefferson” is a rarer term, resulting in a higher TF-IDF weighing.

The degree of relatedness may be refined by metrics involving metadata of candidate items. For example, the publication dates of “T” and “I” can be compared for timeline proximity. If “T” and “I” are published within seven days of each other, a higher related score may result than compared to if “T” and “I” are published several years apart.

In implementations, the set of criteria for both determining channel matches and the degree of relatedness can include the output of natural language processing or statistical classification.

Applying (106) the data channels to identify one or more additional items related to the first item can include applying speech to text to determine words from speech in an audio/video item in order to determine data channel match. Applying (106) can include other machine learning or statistical techniques. For example, data channels may involve text terms which can be matched against the speech to text output for the video clip. In implementations, the confidence scores from the speech to text output can also contribute to the degree of match and the degree of relatedness.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); and so forth.

It should also be understood that, unless clearly indicated to the contrary, in any methods claimed herein that include more than one step or act, the order of the steps or acts of the method is not necessarily limited to the order in which the steps or acts of the method are recited.

What is claimed is:

1. A method comprising:
in a computing system having a processor and memory, processing data channels, each data channel defining a set of criteria against which to match items, each of the items selected from the group consisting of a text document, an audio clip, a video clip, an image, a set of text documents, a set of audio clips, and a set of video clips, the set of criteria selected from the group consisting of search words, metadata criteria, and generated metadata criteria;
receiving an input item in the computing system; and
applying the data channels to identify one or more additional items related to the input item.

2. (canceled)

3. The method of claim 1 wherein the data channels comprise a Boolean tree of criteria.

4. The method of claim 1 wherein processing data channels comprises analyzing trending topics on the world wide web (WWW).

5. The method of claim 1 further comprising applying the data channels to identify a degree of relatedness between the input item and the one or more additional items.

6. The method of claim 5 wherein applying the data channels to identify a degree of relatedness comprises determining a number of data channels in common to which the input item and the one or more additional items belong.

7. The method of claim 6 wherein the degree of relatedness is refined by a relevance score for the number of data channels in common with the input item and the one or more additional items.

8. The method of claim 7 wherein the relevance score is derived from a number of nodes matched in a Boolean tree representation of the data channel set of criteria.

9. The method of claim 7 wherein the relevance score is derived from a number of matches in the input item for a match criterion.

10. The method of claim 6 wherein the degree of relatedness is refined by metrics involving metadata of candidate items.

11. The method of claim 1 wherein the set of criteria further includes an output of natural language processing or statistical classification.

12. The method of claim 1 wherein applying the data channels to identify one or more additional items related to the input item comprises applying speech to text to determine words from speech in an audio/video item in order to determine data channel match.

13. The method of claim 1 wherein applying the data channels to identify one or more additional items related to the input item further comprises other machine learning or statistical techniques.

14. (canceled)

15. The method of claim 1 wherein processing data channels further comprises a user input of criteria.

16. The method of claim 1 wherein the data channels are automatically generated.
